(19) United States
(12) Patent Application Publication
(10) Pub. No.: US 2002/0186151 A1
(43) Pub. Date: Dec. 12, 2002

(54) Method and device for drawing attention to a product before sale of the product

(76) Inventor: Michael Greenberg, Gladstone, NJ (US)

Correspondence Address: BACON & THOMAS, PLLC, 625 SLATERS LANE, FOURTH FLOOR, ALEXANDRIA, VA, 22314

(21) Appl. No.: 09/876,098

(22) Filed: Jun. 8, 2001

(51) Int. Cl. H04Q 1/00; G08B 23/00

(52) U.S. Cl. 340/999

(57) ABSTRACT

An electrically-powered element of a product is intermittently activated prior to sale of the product in order to attract attention to the product. The electrically powered element may be a lighting element, a sound effects device, or a motor included in the product as part of the normal design of the product, for use following sale of the product. The circuit that causes the intermittent activation may be arranged to be disconnected or deactivated following sale of the product.

### BACKGROUND OF THE INVENTION

1. Field of the Invention

This invention generally relates to the field of retail marketing and in particular to a device and method for promoting a product, such as a toy, before sale of the product.

The device and method of the invention automatically activates an element that would normally be activated by a user following purchase of the product, thereby drawing attention to the product without the need for a separate power supply, and without requiring the addition of auxiliary elements intended specifically for product promotion and useless for other purposes.

The element activated by the device and method of the invention may be a lighting element, a sound effects device or speech generator, or an electrically activated motor or other mechanism. In the case where the element to be activated prior to purchase is a lighting element, the lighting element may be caused to flash intermittently while the product is sitting on the store shelf prior to sale.

2. Description of Related Art

Volume retailers such as department stores, discount variety stores, and toy stores, often arrange similar products on long shelf structures separated by aisles through which shoppers meander with shopping carts and baskets. Sales of the similar products depend to a great degree on the ability of the product to catch the shopper's eye, and in particular on product placement.

Placement of the product at a favored position on the shelf is generally granted only to those manufacturers or distributors with the greatest market power, forcing all other manufacturers and distributors to rely on packaging to a potential purchaser's attention. However, due to limitations of conventional product packaging, reliance on the conventional packaging alone is unlikely to overcome the marketing disadvantages of poor product positioning, making it very difficult for smaller manufacturers or distributors to gain market share for their products.

One way to draw a shopper's attention to a product is to vary the illumination of the product on the display shelf, or to attach sales promotion device such as blinking lights to the display shelf. Examples of such shelf display illumination devices are disclosed in U.S. Pat. Nos. 6,012,244 and 4,924,363. However, such devices tend to be most useful for products already placed at favorable positions on the shelf. In addition, shelf illumination devices have the disadvantages that placement of the devices requires cooperation from store management, which tends to favor higher volume, better known manufacturers, and also that they are prone to abuse by children and others, requiring relatively high maintenance.

In an effort to further distinguish a product's packaging from the packaging of similar products, U.S. Pat. No. 5,243,504 proposes to add a blinking light circuit directly to the packaging of a product. However, while addition of a lighting element and corresponding control circuit directly to product packaging is more efficient than a store shelf display at drawing attention to an individual product, the need for a separate battery and light source adds to the cost of the packaging, and therefore of the product. In addition, even where the cost of the added light source and circuit is relatively low relative to the overall cost of the product and/or packaging, the added light source may nevertheless cause some consumers to shun the product based on concerns about the environment, or simply because the light is perceived as adding to the cost of the product without corresponding benefit to the purchaser (although the '504 patent claims that the light can be removed and used as a novelty badge or pin).

Similar problems arise with the stick-on LED flasher disclosed in U.S. Pat. No. 6,013,346, or the flasher buttons or accessories disclosed in U.S. Pat. No. 5,143,439, when used for promotional purposes. While the lighting elements on the stick-on flasher button or accessories disclosed in these patents may be useful for drawing attention to an article or product on which they are placed, the use of a battery and light circuit for promotional purposes is costly and likely to be perceived as wasteful and lacking in value to the consumer.

In addition to the problem of increasing cost without providing corresponding benefits to the consumer, the concept of using add-on flashing lights only is useful for products placed in the line of sight of the consumer. Products might be hidden behind other products, at angles not visible to consumers of all heights, or in positions where ambient lighting conditions overwhelm lighting elements on the product, in which case a flashing light would not be seen or noticed. In such cases, adding sound or motion might be more effective at drawing the shopper's attention.

Another way to draw attention to a product is to simply turn on a display sample of the product so that it carries out its normal post-sale function. For example, a toy police car with a flashing light function might simply be turned on and thereby caused to flash without the addition of any sort of pre-sale activation circuit. While this might be effective in drawing attention to the product, the flashing lights, sounds, or other effects in such products are designed for private use and can easily cause annoyance in a retail setting, due to excessively bright lights, loud sounds, or distracting motion. Moreover, leaving a product on in order to draw attention to it can drain the product's power source and reduce the useful lifespan of the product. In general, the approach of turning on a product and leaving the product on using its normal post-sale activation circuits to draw attention to the product will work best if the product is normally activated by the presence of a person, for example by means of a motion or heat sensor. Such motion or heat sensors are relatively expensive and are suitable for use in only a few products. In contrast, the present invention provides a dedicated pre-sale circuit that is specifically designed to draw attention to a product prior to its sale, by intermittently or periodically activating a light, sound, or motion device on the product in such a way that attention is drawn to the product without annoying the customer, and without excessive power consumption.

### SUMMARY OF THE INVENTION

It is accordingly a first objective of the invention to provide a device and method for promoting a product by intermittently or periodically initiating an attention-attracting event, such as flashing of a light, and yet that does not add significantly to the cost of the product, or give the impression of added cost without corresponding benefit to the purchaser.

It is a second objective of the invention to provide a product promotional device and method that periodically or intermittently initiates an attention-attracting event, such as flashing of a light, and yet does not require the addition of either a battery or a light to the product, its packaging, or to the shelf or display on which the product is placed.

It is a third objective of the invention to provide a device and method for enhancing the visibility of a product situated on a store shelf or in a display of similar products by causing a light to flash, without the need for cooperation by the store, or the use of a battery or lighting element apart from that already provided in the product in question.

It is a fourth objective of the invention to provide a device and method for drawing attention to a product that can easily be adapted to use lights, sounds, and even motion, depending on the nature of the product.

These objectives of the invention are achieved, in accordance with the principles of a preferred embodiment of the invention, by providing a device in the form of a circuit arranged to be connected between a power source and a lighting element, and/or between the power source and another element capable of attracting attention to the product when activated, for periodically or intermittently activating the light or other element, in order to draw attention to the product for at least long enough to cause a potential purchaser to consciously notice the product, the lighting or other element and the power source being integral components of the product that carry out ordinary functions of the product apart from the promotional function, and that therefore do not add to the actual or perceived value of the product.

In an especially preferred embodiment of the invention, the product is a child's toy, such as a toy vehicle or infant's toy, having lights that illuminate during play. Such toys are often supplied by the manufacturer with batteries before the product is displayed so that prospective purchasers can try out the lighting effects while the toys are on the store shelf. The invention may be implemented by including a simple integrated circuit connected between the battery and at least one of the lights so as to cause the light or lights to flash periodically or intermittently for brief intervals while being displayed.

The circuit may be arranged to be disconnected upon some event associated with removal of the toy from its packaging, or upon use of the toy, or the device may be preset to flash for a predetermined period of time sufficient to ensure sale of the product. In the case of a toy that already exhibits flashing or other lighting effects, the circuit of the invention may be arranged simply to initiate a pre-programmed sequence of lighting effects.

In addition, the circuit used in the preferred embodiment of the invention may be arranged, instead of or in addition to activating a lighting element, to initiate sound effects, activate a motor, and/or otherwise cause an event that will draw attention to the product.

### BRIEF DESCRIPTION OF THE DRAWINGS

FIG. 1 is a schematic illustration of a product arranged, in accordance with the principles of a preferred embodiment of the invention, to include a lighting element arranged to flash prior to purchase so as to attract the attention of prospective purchasers.

FIG. 2 is a schematic illustration of a product including a special effects circuit controlled by a pre-purchase activation circuit according to the principles of a second preferred embodiment of the invention.

FIG. 3 is a schematic circuit diagram showing details of a pre-purchase lighting effects circuit constructed according to the principles of the preferred embodiment of the invention.

FIG. 4 is a schematic circuit diagram showing details of an alternative pre-purchase lighting effects circuit.

FIG. 5 is a schematic diagram of a switch which may be used in connection with the pre-purchase lighting effects circuits of the preferred embodiments of the invention.

FIG. 6 is a schematic diagram of a further variation of the pre-purchase lighting effects circuits of the preferred embodiments of the invention.

### DETAILED DESCRIPTION OF THE PREFERRED EMBODIMENTS

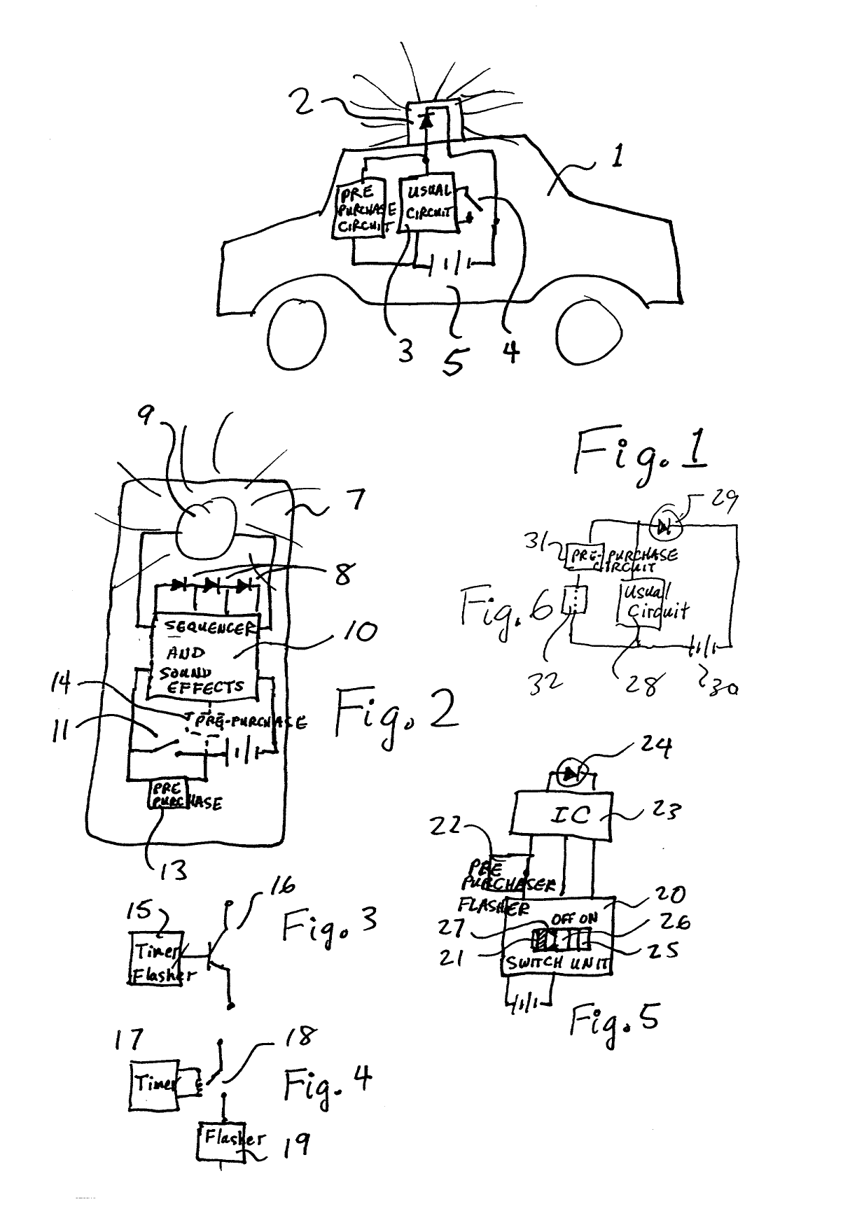

FIG. 1 shows a product to which a pre-purchase product-promotional circuit has been added in accordance with the principles of a first preferred embodiment of the invention. The product is in the form of a toy 1, for example a toy police vehicle, with a light emitting diode (LED) 2 that is normally illuminated or caused to flash by a conventional circuit 3 activated by a main on/off switch 4 and powered by one or more batteries 5. The toy vehicle is packaged in such a way that the switch is accessible through the packaging (not shown) so that potential purchasers can try out the lighting effects by manipulating the switch prior to purchase. As a result, batteries are installed by the manufacturer and power is available while the product is on the display shelf.

The present invention modifies the conventional product by adding a pre-purchase circuit connected in parallel with the conventional light-activation circuit 3. The pre-purchase circuit 6 may simply be a switch controlled by a timer circuit which intermittently causes the switch to close and thereby by-pass the conventional circuit 3, causing the LED 2 to flash even though main on/off switch 4 has not been pushed.

The intervals at which pre-purchase circuit 6 causes LED 2 to flash are preferably chosen so that a person walking past the product will see at least one flash during the time that the product is in view. While the duty cycle of the pre-purchase circuit should be as low as possible in order to save power, it is within the scope of the invention to provide multiple flashes within a short interval, flashes of varying duration, and/or patterns of flashes in order to make the flashing light more visible to a passing consumer.

Preferably, the pre-purchase circuit is in the form of an inexpensive integrated circuit that can easily be added to the product without changing the basic design or function of the product, although those skilled in the art will appreciate that the pre-purchase circuit of the invention may also be implemented in the form of discrete electronic and/or electromechanical circuit elements or components.

In addition, it will be appreciated by those skilled in the art that the product in which the pre-purchase circuit is installed need not be a toy vehicle, and that the lighting element in question need not be an LED. Instead, it is contemplated that the pre-purchase circuit of the invention may be used in a variety of illuminated toys and other products, ranging from infant toys to illuminated sports equipment, with lighting elements including incandescent lights, fluorescent tubes, and electro-luminescent strips or panels.

An example of an infant toy 7 to which the principles of a second preferred embodiment of the invention are applied is shown in FIG. 2. The toy of FIG. 2 includes a sequence of lighting elements 8 and a speaker 9 controlled by an integrated circuit 10 arranged to cause the lights to flash according to a predetermined pattern while sound effects or tunes are played through the speaker in response to closure of a switch 11. The switch may be manually activated, or activated by motion or vibration of the toy. Power is supplied by one or more batteries 12 pre-installed by the manufacturer so as to be available while the product is displayed prior to sale. The pre-purchase circuit, represented by circuit 13, may again be in the form of a timer activated switch, but instead of directly activating one or more of the lights, the pre-purchase circuit 13 is arranged to activate the conventional lights and sound controlling integrated circuit 10, causing the integrated circuit 10 to initiate one of its normal pre-programmed sequences of lights and sounds. Alternatively, the pre-purchase circuit may be connected in the manner of circuit 14, shown in dashed lines, to a separate input of the integrated circuit 10 so as to cause the integrated circuit 10 to provide a more limited pre-purchase sequence of lights and sounds than the normal sequence exhibited following purchase.

It will of course be appreciated that the sounds generated in response to activation by the pre-purchase circuit may be different from those generated during normal use of the product, and may include musical sounds, voice messages, and other sound effects. The voice messages could, for example, be promotional messages such as “try me!”

FIGS. 3 and 4 show two implementations of the pre-purchase circuit of the preferred embodiments. In the implementation shown in FIG. 3, a combined timer/flasher circuit 15 controls a transistor 16 to initiate pre-purchase attention drawing events, while in the implementation of FIG. 4, a timer 17 controls a relay 18, which in turn activates a flasher circuit 19. Numerous other timer/flasher/switch combinations will undoubtedly occur to those skilled in the art and the invention is of course intended to encompass all such variations, so long as the pre-purchase circuit is arranged to cause an event, such as flashing of a light, activation of sound effects, or even brief activation of a motor, to occur without human intervention prior to purchase of a product.

An especially simple pre-purchase circuit replaces the timer with a switch unit 20. Switch 20 is initially positioned at a pre-purchase position 21 in which the normal on/off functions of the switch 20 are by-passed so as to cause power to be intermittently supplied through a pre-purchase flasher circuit 22 to integrated circuit 23, or directly to lighting element 24, so long as the switch is in the pre-purchase position. When the product is purchased, the user moves the switch to a marked ON position 25 so as to operate the product in normal fashion, and to a marked OFF position 26 when operation is no longer desired. A detent 27 or similar mechanism prevents the switch from being moved back to the unmarked pre-purchase position following initial operation.

An alternative arrangement which effects disconnection of the pre-purchase circuit following sale is shown in FIG. 6. The arrangement shown in FIG. 6 includes a conventional circuit 28 for connecting an element 29 to be activated with a power supply 30 during normal use of the product, and a pre-purchase circuit connected in parallel with the conventional circuit 28, between the power supply 30 and the element 29 to be activated.

A wire or other connection between the pre-purchase circuit 31 and the power supply runs through or across, or includes, a breakaway connection element 32 that disconnects the pre-purchase circuit from the power supply so that the pre-purchase circuit will not continue to flash following purchase of the product. The breakaway connection element 32 may be mechanically linked to the packaging so as to break the circuit upon removal of the product from its package, or the breakaway connection element may be attached to a tab arranged to be pulled away by the user following purchase of the product so as to break the circuit when the user is ready to use the product. Alternatively, the disconnection may be arranged to occur upon expiration of a preset time period following manufacture or assembly of the product, the preset time period corresponding to the estimated length of the pre-purchase period.

Having thus described a number of preferred embodiments of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

We claim:

1. A device for attracting attention to a product before sale of the product, said product including a power supply, an element connected to the power supply and activated during use of the product following sale, and a normal use circuit connected between the power supply and the element for activating the element during said use of the product following sale, said device comprising:
a pre-purchase circuit connected between said power supply and one of said element and said normal use circuit, said pre-purchase circuit being arranged to intermittently activate said element prior to sale of the product.

2. A device as claimed in claim 1, wherein said element is a lighting element, and said pre-purchase circuit is arranged to cause said lighting element to flash intermittently prior to said sale of the product.

3. A device as claimed in claim 2, wherein said lighting element is a light emitting diode.

4. A device as claimed in claim 1, wherein said product is a toy.

5. A device as claimed in claim 1, wherein said pre-purchase circuit includes a timer and a flasher circuit.

6. A device as claimed in claim 1, wherein said pre-purchase circuit is connected in parallel with said normal use circuit, between said power supply and said element.

7. A device as claimed in claim 1, wherein said normal use circuit is an integrated circuit, and said pre-purchase circuit is connected between said power supply and said normal use circuit in order to activate said normal use circuit and thereby intermittently activate said element.

8. A device as claimed in claim 1, wherein said element is a sound effects device.

9. A device as claimed in claim 1, wherein said pre-purchase circuit includes a switch having a pre-purchase position, said switch being arranged to be moved to a normal on/off position by a user following purchase of the product.

10. A device as claimed in claim 9, further comprising detent structures for preventing return of said switch to the pre-purchase position following movement of the switch to the normal on/off position.

11. A device as claimed in claim 1, wherein said pre-purchase circuit includes an integrated circuit.

12. A device as claimed in claim 1, wherein said pre-purchase circuit is arranged to be disconnected from said power supply following purchase of the product.

13. A device as claimed in claim 12, wherein said disconnection is arranged to be effected upon removal of said product from packaging.

14. A device as claimed in claim 12, wherein said disconnection is arranged to be effected upon removal of a tab from said product.

15. A device as claimed in claim 12, wherein said disconnection is effected a predetermined period of time after activation of said pre-purchase circuit following assembly of the product.

16. A method of attracting attention to a product before sale of the product, said product including a power supply, an element connected to the power supply and activated during use of the product following sale, and a normal use circuit connected between the power supply and the element for activating the element during said use following sale, said method comprising the step of:
intermittently activating said element prior to sale of the product.

17. A method as claimed in claim 16, further comprising the step of discontinuing activation of said element upon movement of a switch to a normal operating position following purchase.

18. A method as claimed in claim 16, further comprising the step of discontinuing activation of said element of disconnection of a pre-purchase circuit that carries out said step of intermittently activation said element prior to sale of the product.

19. A method as claimed in claim 18, wherein the step of discontinuing activation of said element consists of the step of removing said product from a package.

20. A method as claimed in claim 18, wherein the step of discontinuing activation of said element includes the step of removing a tab from said product.
